(19) United States
(12) Patent Application Publication
(10) Pub. No.: US 2008/0139304 A1
(43) Pub. Date: Jun. 12, 2008

(54) GAMING APPARATUS AND PLAYING METHOD OF CARD GAME

(75) Inventor: Yukinori INAMURA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/936,354

(22) Filed: Nov. 7, 2007

(30) Foreign Application Priority Data
Nov. 27, 2006 (JP) 2006-319089

(51) Int. Cl. A63F 13/00

(52) U.S. Cl. 463/26

(57) ABSTRACT

The gaming apparatus of the present invention provides a gaming apparatus comprising: a display capable of displaying a plurality of cards; an input switch with which a player can input a hold and/or a change; and a controller programmed so as to execute the processing of: (a) displaying a plurality of cards to the display; (b) detecting the input of a hold and/or a change from the input switch; (c) exchanging a card according to the detection; (d) determining a prize according to a combination of the plurality of cards after the exchange; and (e) generating a bonus when the determined prize is a higher prize among a plurality of prizes.

### CROSS-REFERENCE TO RELATED APPLICATIONS

This application claims benefit of priority based on Japanese Patent Application No. 2006-319089 filed on Nov. 27, 2006. The contents of this application are incorporated herein by reference in their entirety.

### BACKGROUND OF THE INVENTION

1. Field of the Invention

The present invention relates to a gaming apparatus such as a video poker machine, and a playing method of a card game such as poker.

2. Discussion of the Background

There conventionally exist gaming apparatuses a subject game of which is playing cards, especially poker (e.g. UK Patent No. 2,169,737). UK Patent No. 2,169,737 discloses placing a bet by playing a poker game. Further, a game is displayed in which a part of credits betted by players in a plurality of gaming apparatuses are stored and this stored credit is paid out as a jackpot to a player for whom a bonus has been generated (e.g. U.S. Pat. No. 7,081,050)

The contents of UK Patent No. 2,169,737 and U.S. Pat. No. 7,081,050 are incorporated herein by reference in their entirety.

The object of the present invention is to provide a new entertaining property nonexistent in the foregoing conventional arts. Specifically, the present invention is to provide a gaming apparatus and a playing method of a card game which are capable of heightening expectations for a higher prize among a plurality of prizes.

### SUMMARY OF THE INVENTION

In order to achieve the foregoing object, a first aspect of the present invention provides a gaming apparatus having the following configuration.

(1) Namely, the gaming apparatus comprises: a display capable of displaying a plurality of cards; an input switch with which a player can input a hold and/or a change; and a controller. The controller is programmed so as to execute the processing of (a) displaying a plurality of cards to the display; (b) detecting an input of a hold and/or a change from the input switch; (c) exchanging a card according to the detection; (d) determining a prize according to a combination of the plurality of cards after the exchange; and (e) generating a bonus when the determined prize is a higher prize among a plurality of prizes.

According to the invention of (1), when a prize determined according to a combination of the cards is a higher prize among a plurality of prizes (e.g. a prize which is ranked equal to or higher than Full House in the case of a poker game), a bonus (e.g. free game, second game) is generated. As thus described, a bonus is generated when a higher prize among a plurality of prizes is determined as the prize. It is thus possible to heighten expectations for a higher prize so as to provide a more entertaining game.

A second aspect of the present invention provides a gaming apparatus having the following configuration.

(2) Namely, the gaming apparatus comprises: a display capable of displaying a plurality of cards; an input switch with which a player can input a hold and/or a change; and a controller. The controller is programmed so as to execute the processing of: (a) displaying a plurality of cards to the display; (b) detecting an input of a hold and/or a change from the input switch; (c) exchanging a card according to the detection; (d) determining a prize according to a combination of the plurality of cards after the exchange; and (e) paying out a progressive jackpot made by cumulatively accumulating apart of abet from each player, when the determined prize is a higher prize among a plurality of prizes.

According to the invention of (2), when a prize determined according to a combination of the cards is a higher prize among a plurality of prizes, a progressive jackpot, which is made by cumulatively accumulating a part of a bet from the player, is paid out. As thus described, when a higher prize among a plurality of prizes is determined as the prize, a progressive jackpot is paid out so that the player can acquire a large currency value which has been cumulatively accumulated. It is thus possible to heighten expectations for a higher prize so as to provide the player with a more entertaining game.

A third aspect of the present invention provides a gaming apparatus having the following configuration.

(3) Namely, the gaming apparatus comprises: a display capable of displaying a plurality of cards; an input switch with which a player can input a hold and/or a change; and a controller. The controller is programmed so as to execute the processing of: (a) transmitting currency value information showing a currency value betted by the player, to a server connected via a communication line; (b) displaying a plurality of cards to the display; (c) detecting an input of a hold and/or a change from the input switch; (d) exchanging a card according to the detection; (e) determining a prize according to a combination of the plurality of cards after the exchange; and (f) when the determined prize is a higher prize among a plurality of prizes, acquiring jackpot information showing a progressive jackpot from the server in which at least a part of the currency value that the currency value information shows is cumulatively accumulated as the progressive jackpot, and also paying out the progressive jackpot shown by the jackpot information.

According to the invention of (3), currency value information showing a currency value betted by the player is transmitted to a server connected via a communication line. In the server, at least apart of the currency value that the currency value information shows is cumulatively accumulated as a progressive jackpot. When a prize determined by a combination of the plurality of cards is a higher prize among a plurality of prizes, jackpot information showing the progressive jackpot is acquired from the server, and the progressive jackpot shown by the jackpot information is paid out. As thus described, when a higher prize among a plurality of prizes is determined as the prize, the progressive jackpot is paid out so that the player can acquire a large currency value which has been cumulatively accumulated. It is thus possible to heighten expectations for a higher prize so as to provide the player with amore entertaining game.

A fourth aspect of the present invention provides a gaming apparatus having the following configuration.

(4) Namely, the gaming apparatus comprises: a display capable of displaying a plurality of cards; an input switch with which a player can input a hold and/or a change; and a controller. The controller is programmed so as to execute the processing of: (a) transmitting currency value information showing a currency value betted by the player, to a server connected via a communication line; (b) displaying a plurality of cards to the display; (c) detecting an input of a hold and/or a change from the input switch; (d) exchanging a card according to the detection; (e) determining a prize according to a combination of the plurality of cards after the exchange; and (f) when the determined prize is a higher prize among a plurality of prizes, acquiring jackpot information showing a progressive jackpot corresponding to the determined higher prize from the server in which at least a part of the currency value that the currency value information shows is cumulatively accumulated as a plurality of types of progressive jackpots, and also paying out the progressive jackpot shown by the jackpot information.

According to the invention of (4), currency value information showing a currency value betted by the player is transmitted to a server connected via a communication line. In the server, at least apart of the currency value that the currency value information shows is cumulatively accumulated as a plurality of types of progressive jackpots. When a prize determined by a combination of the cards is a higher prize among a plurality of prizes, jackpot information showing the progressive jackpot is acquired from the server, and the progressive jackpot shown by the jackpot information is paid out. As thus described, when a higher prize among a plurality of prizes is determined as the prize, the progressive jackpot is paid out so that the player can acquire a large currency value which has been cumulatively accumulated. It is thus possible to heighten expectations for a higher prize so as to provide the player with a more entertaining game.

Further, since a plurality of types of jackpots exist and a progressive jackpot corresponding to the determined higher prize is paid out, the amount of the progressive jackpot to be paid out can be varied according to the possibility of establishment of each higher prize. Moreover, it is possible to motivate the player to challenge establishment of an even higher prize.

The first aspect of the present invention provides a playing method of a card game including the following steps.

(5) Namely, the playing method of a card game comprises the steps of: (a) dealing a plurality of cards; (b) exchanging a card according to a hold and/or a change; (c) determining a prize according to a combination of the plurality of cards after the exchange; and (d) offering a bonus to a player when the determined prize is a higher prize among a plurality of prizes.

According to the invention of (5), when a prize determined according to a combination of the cards is a higher prize among a plurality of prizes, a bonus is offered to the player. As thus described, a bonus is offered to the player when a higher prize among a plurality of prizes is determined as the prize.

It is thus possible to heighten expectations for a higher prize so as to provide a more entertaining game.

The second aspect of the present invention provides a playing method of a card game including the following steps.

(6) Namely, the playing method of a card game comprises the steps of: (a) dealing a plurality of cards; (b) exchanging a card according to a hold and/or a change; (c) determining a prize according to a combination of the plurality of cards after the exchange; and (d) paying out to a player a progressive jackpot made by cumulatively accumulating a part of a bet from each player, when the determined prize is a higher prize among a plurality of prizes.

According to the invention of (6), when a prize determined according to a combination of the cards is a higher prize among a plurality of prizes, a progressive jackpot made by cumulatively accumulating a part of a bet from each player is paid to the player. As thus described, when a higher prize among a plurality of prizes is determined as the prize, a progressive jackpot is paid out so that the player can acquire a large currency value which has been cumulatively accumulated. It is thus possible to heighten expectations for a higher prize so as to provide the player with a more entertaining game.

According to the present invention, it is possible to provide an entertaining property not provided by the foregoing conventional arts, namely, a gaming apparatus and a playing method of a card game which are capable of heightening expectations for a higher prize among a plurality of prizes.

### BRIEF DESCRIPTION OF THE DRAWINGS

FIG. 1 is a view showing an exemplary image displayed to a lower image display panel.

FIG. 2 is a view showing an exemplary image displayed to an upper image display panel.

FIG. 3 is a schematic view showing an entire configuration of a game system according to one embodiment of the present invention.

FIG. 4 is a perspective view schematically showing a gaming apparatus according to one embodiment of the present invention.

FIG. 5 is a block diagram showing an internal configuration of the gaming apparatus shown in FIG. 4.

FIG. 6 is a block diagram showing an internal configuration of the server shown in FIG. 4.

FIG. 7 is a view showing an exemplary progressive jackpot storage table.

FIG. 8 is a flowchart showing a subroutine of game execution processing executed by a gaming apparatus.

FIG. 9 is a flowchart showing a subroutine of accumulation processing executed by a server.

### DESCRIPTION OF THE EMBODIMENTS

The first aspect of the present invention is an invention of generating a bonus when a determined prize is a higher prize among a plurality of prizes. The second aspect of the present invention is the first aspect of the present invention of paying out a progressive jackpot when the determined prize is a higher prize among a plurality of prizes. The third aspect of the present invention is the second aspect of the present invention of accumulating the progressive jackpot in a server. The fourth aspect of the present invention is the third aspect of the present invention having a plurality of progressive jackpots.

In the following description, the first, second, third and fourth aspects of the present inventions are simply referred to as the present invention when not particularly distinguished.

Examples of the present invention are described based on drawings.

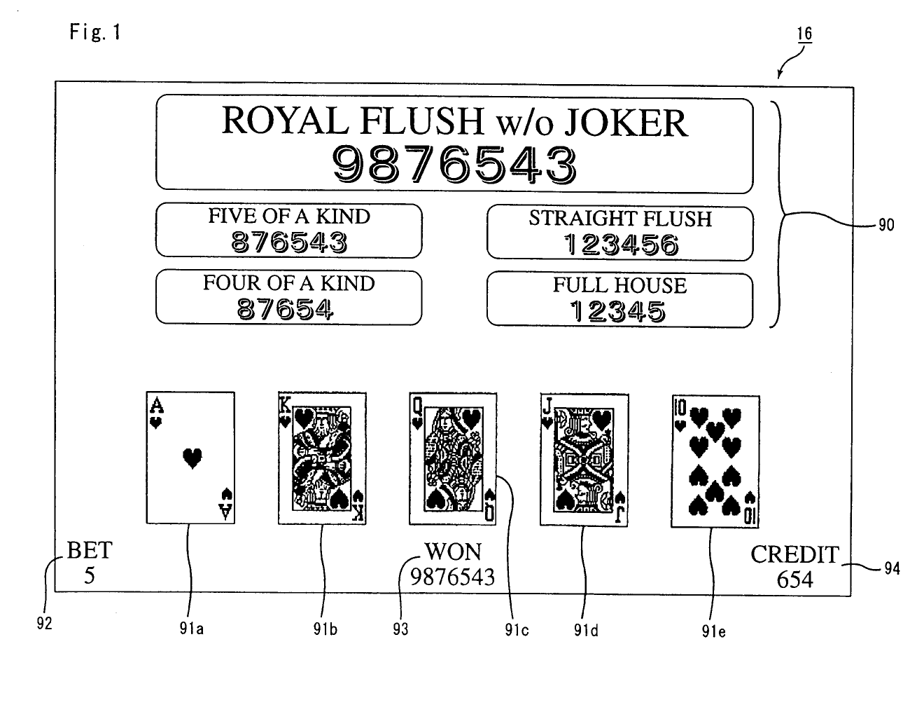

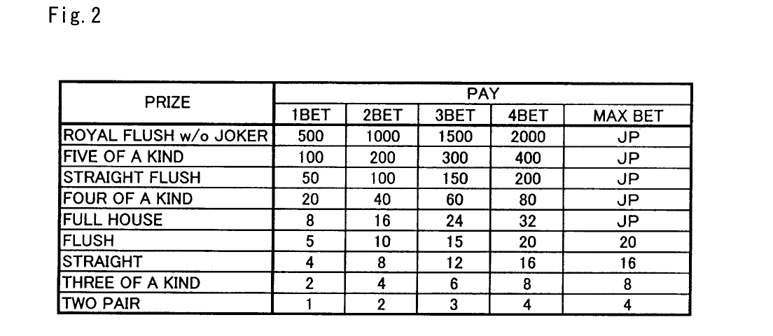

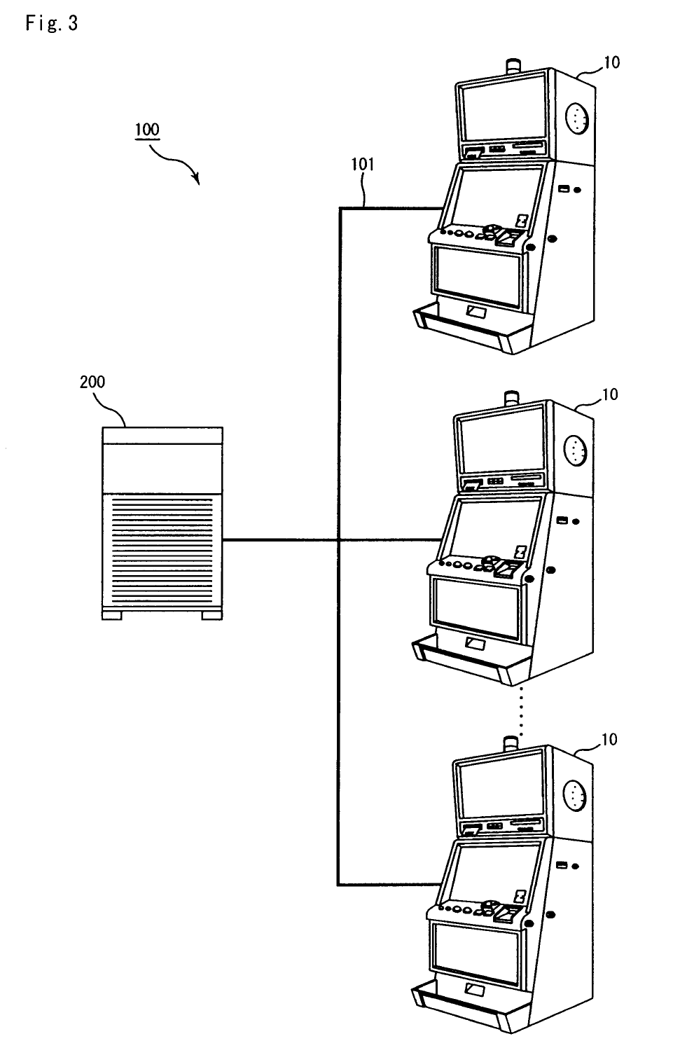

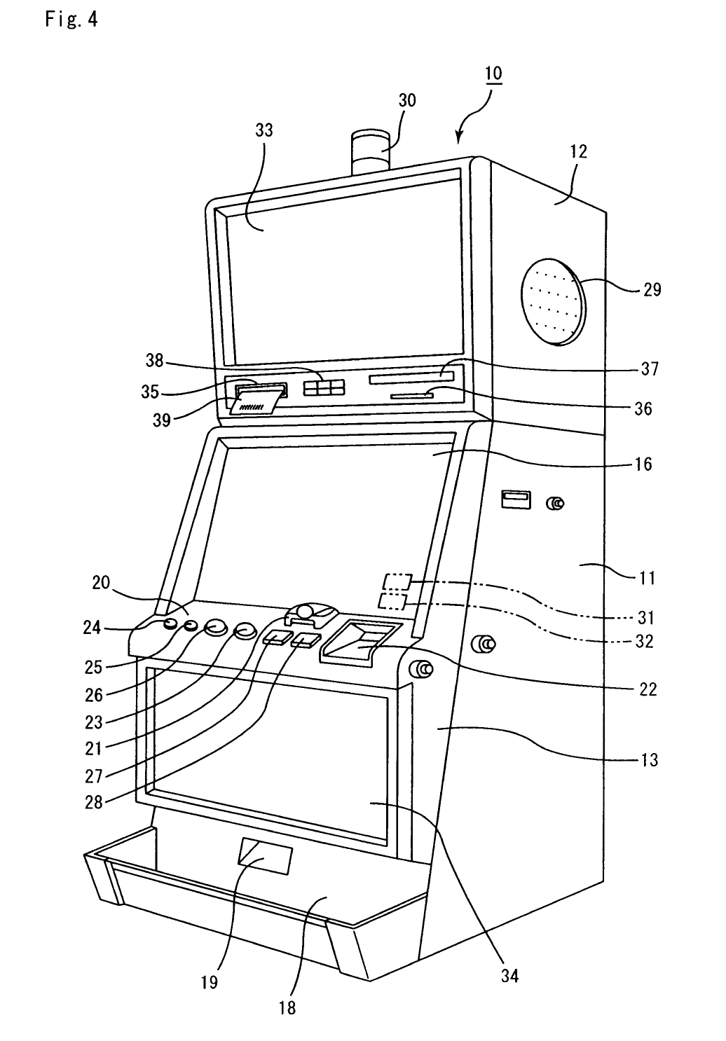

FIG. 1 is a view showing an exemplary image displayed to a lower image display panel. FIG. 2 is a view showing an exemplary image displayed to an upper image display panel. FIG. 3 is a schematic view showing an entire configuration of a game system according to one embodiment of the present invention. FIG. 4 is a perspective view schematically showing a gaming apparatus according to one embodiment of the present invention. It is to be noted that, although a gaming apparatus 10 is a gaming apparatus connected with a server 200 via a network, the present invention is also applicable to a stand-alone type gaming apparatus not connected to a network.

A poker game is played in the gaming apparatus 10, and when a combination of five cards (hand) is a predetermined combination, namely, when the combination corresponds to a predetermined prize, a payout corresponding to the prize is conducted. It is to be noted that, although a description is given taking a poker game as an example in the present embodiment, a card game in the present invention is not limited to this example, and not particularly limited so long as being a game in which a prize is determined according to a combination of the cards.

As shown in FIG. 1, a JP image 90 showing the value of each current progressive jackpot (hereinafter also referred to as “JP”) is displayed on the upper side of a lower image display panel 16 included in the gaming apparatus 10 of the present invention. Specifically, a JP image 90 displays that 9876543 coins have been accumulated as a JP for ROYAL FLUSH. It is to be noted that, when the prize of ROYAL FLUSH is established using a joker, it is treated as STRAIGHT FLUSH. Further, the JP images 90 display to the lower image display panel 16 that 876543 coins have been accumulated as a JP for FIVE OF A KIND, 123456 coins have been accumulated as a JP for STRAIGHT FLUSH, 87654 coins have been accumulated as a JP for FOUR OF A KIND, and 12345 coins have been accumulated as a JP for FULL HOUSE. The JP corresponds to the bonus in the first aspect of the present invention.

Although a case is described in the present embodiment where the bonus in the first aspect of the present invention is a payout of a JP, it is not limited to this example. For example, the bonus may be a payout of a predetermined number of coins (e.g. 1000 coins) or may be execution of a second game in which a relatively large number of coins can be acquired.

On the lower side of the JP image 90, card images 91 showing five cards (91a, 91b, 91c, 91d, 91e) are displayed. FIG. 1 shows that the card image 91a is A of Hearts, the card image 91b is K of Hearts, the card image 91c is Q of Hearts, the card image 91d is J of Hearts, and the card image 91e is 10 of Hearts, and thus the prize of ROYAL FLUSH has been established.

On the lower side with respect to the card images 91, a number-of-bets display portion 92, a number-of-acquired-coins display portion 93 and a number-of-credits display portion 94 are displayed in the order from the left. The number-of-bets display portion 92 displays the number of coins having been betted on the current game. The number-of-acquired-coins display portion 93 displays as an image the number of coins to be paid out when the combination of the cards is a predetermined combination. The number-of-credits display portion 94 displays as an image the number of coins credited.

As shown in FIG. 2, a correspondence table (payout table) of prizes and the numbers coin-outs is displayed to an upper image display panel 33.

Specifically, for example, for a game in which the prize of ROYAL FLUSH is established, the table displays that: 500 coins are to be paid out in the case of 1 BET; 1000 coins are to be paid out in the case of 2 BETs; 1500 coins are to be paid out in the case of 3 BETs; and 2000 coins are to be paid out in the case of 4 BETs. Further, for a game in which the prize of ROYAL FLUSH is established, the JP for ROYAL FLUSH is to be paid out in the case of MAXBET (5 BETs).

Similarly, the table displays that coins or a JP according to the number of BETs are paid out for the respective prizes of FIVE OF A KIND, STRAIGHT FLUSH, FOUR OF A KIND, FULL HOUSE, FLUSH, STRAIGHT, THREE OF A KIND, and TWO PAIR.

In the gaming apparatus 10, when a game is played with the MAXBET placed thereon, the JP corresponding to each prize is to be paid out in establishment of the prize of ROYAL FLUSH, FIVE OF A KIND, STRAIGHT FLUSH, FOUR OF A KIND or FULL HOUSE.

Further, the number of coin-outs for 4 BETs are the same as that for 5 BETs in FLUSH, STRAIGHT, THREE OF A KIND and TWO PAIR.

ROYAL FLUSH, FIVE OF A KIND, STRAIGHT FLUSH, FOUR OF A KIND and FULL HOUSE correspond to the higher prizes in the present invention. The higher prize refers to a prize with a relatively low possibility of establishment, and there should exist a prize with a higher possibility of establishment than the higher prize.

Although a case is described in the present embodiment where five prizes of ROYAL FLUSH, FIVE OF A KIND, STRAIGHT FLUSH, FOUR OF A KIND and FULL HOUSE are the higher prizes, the number of higher prizes is not limited to five in the present invention.

Further, other than the higher prizes, there may exist a prize with an even lower possibility of establishment than the higher prizes. Namely, for example, four prizes of FIVE OF A KIND, STRAIGHT FLUSH, FOUR OF A KIND and FULL HOUSE may be the higher prizes, and ROYAL FLUSH, which is with a lower possibility of establishment than those four prizes, may not be included in the higher prize.

Moreover, although a case is described in the present embodiment where the JP corresponding to each of the higher prizes is paid out, the number of JP in the first to third aspects of the present invention may be one. Namely, the same JP may be paid out when any of the higher prizes is established.

Furthermore, a case is described in the present embodiment where the JP is paid out in establishment of a higher prize when a game is played with the MAXBET. However, the present invention is not limited to this example, but the JP may be paid out so long as the higher prize is established even with a BET other than the MAXBET.

As shown in FIG. 3, a game system 100 includes a plurality of gaming apparatuses 10 and the server 200 connected to these gaming apparatuses 10 via a predetermined communication line 101. Such a game system 100 may be constructed inside one gaming facility such as a bar or a casino where a variety of games can be played, or may be constructed among a plurality of gaming facilities. Further, in the case of constructing the game system 100 inside one gaming facility, the game system 100 may be constructed on each floor or in each section of the gaming facility. The communication line 101 is not particularly limited but may be wired or wireless, and a dedicated line, an exchange line or the like may be adopted.

In the gaming apparatus 10, a coin, a bill, or electronic valuable information corresponding to these is to be used as a currency value. However, in the present invention, the currency value is not particularly limited, but may be exemplified by a medal, a token, electronic money and a ticket. It is to be noted that the ticket is not particularly limited, but may be exemplified by a ticket with a barcode or the like as described later.

The server 200 cumulatively accumulates a part of coins BET in each gaming apparatus 10. Upon receipt of BET information showing the number of coins BET at each gaming apparatus 10 via the communication line 101, the server 200 divides a part of the BET coins to accumulate as a plurality of JPs. The BET information corresponds to the currency value information in the present invention.

FIG. 4 is a perspective view schematically showing a gaming apparatus according to one embodiment of the present invention.

The gaming apparatus 10 includes a cabinet 11, a top box 12 installed on the upper side of the cabinet 11, and a main door 13 provided on a front surface of the cabinet 11.

At the front face of the main door 13, the lower image display panel 16 is provided as a display. The lower image display panel 16 includes a liquid crystal panel to which five card images 91 (91a, 91b, 91c, 91d, 91e) are displayed.

Although not shown, a touch panel 69 is provided on a front face of the lower image display panel 16, and the player can operate the touch panel 69 to input a variety of commands. For example, the player can operate the touch panel 69 to input a hold or change command, to progress a card game. The touch panel 69 corresponds to the input switch in the present invention. Although a case is described in the present embodiment where a hold and/or a change is inputted through the touch panel 69, the present invention is not limited to this example. For example, a dedicated switch may be provided, or a variety of buttons 23 to 28 may be used.

Below the lower image display panel 16 provided are a control panel 20 comprised of the plurality of buttons 23 to 28 with which a command relating to the game progress is inputted by the player, a coin receiving slot 21 for accepting coins into the cabinet 11, and a bill validator 22.

The control panel 20 is provided with a start button 23, a change button 24, a CASHOUT button 25, a 1-BET button 26, a maximum BET button 27 and a collect button 28. The start button 23 is for inputting a command to start a game. The change button 24 is for making a request of staff for exchange. The CASHOUT button 25 is for inputting a command to pay out credited coins to a coin tray 18.

The 1-BET button 26 is for inputting a command to bet one coin on a game, out of credited coins. The maximum BET button 27 is for inputting a command to bet coins in the maximum number (five coins in the present embodiment) that can be betted on one game, out of credited coins.

The collect button 28 is to be operated after the player acquires the right to receive a payout of JP, namely after establishment of a higher prize in a game with the MAXBET, to confirm the amount of JP; and the JP in amount at the time of operation of the collect button 28 is paid out.

The bill validator 22 not only discriminates a regular bill from a false bill, but also accepts the regular bill into the cabinet 11. It is to be noted that the bill validator 22 may be configured so as to be capable of reading a later-described ticket 39 with a barcode. On a lower front face of the main door 13, namely below the control panel 20, a belly glass 34 is provided on which a character and the like of the gaming apparatus 10 is drawn.

The upper image display panel 33 is provided on the front face of the top box 12. The upper image display panel 33 is provided with a liquid crystal panel to which an image is displayed representing the payout table shown in FIG. 2, introduction of game contents and explanation of the game rule.

Further, a speaker 29 is provided in the top box 12. Below the upper image display panel 33, a ticket printer 35, a card reader 36, a data display 37 and a key pad 38 are provided. The ticket printer 35 prints on a ticket a barcode obtained by encoding data such as the number of credits, a date, an identification number of the gaming apparatus 10, and outputs the ticket as a ticket 39 with a barcode. The player can make another gaming apparatus read the ticket 39 with a bar code, to play a game therein or exchange the ticket 39 with a barcode with a bill or the like at a predetermined place of a gaming facility (e.g. cashier in a casino).

The card reader 36 reads data from a smart card and writes data into the smart card. The smart card is a card owned by the player, and stores, for example, data for identifying the player and data on a history of games played by the player. The smart card may store data corresponding to coins, bills or credits. Further, a magnetic stripe card may be adopted in place of the smart card. The data display 37 is made of a fluorescent display or the like, and displays, for example, data read by the card reader 36 and data inputted by the player via the key pad 38. The key pad 38 is for inputting a command and data regarding ticket issuance and the like.

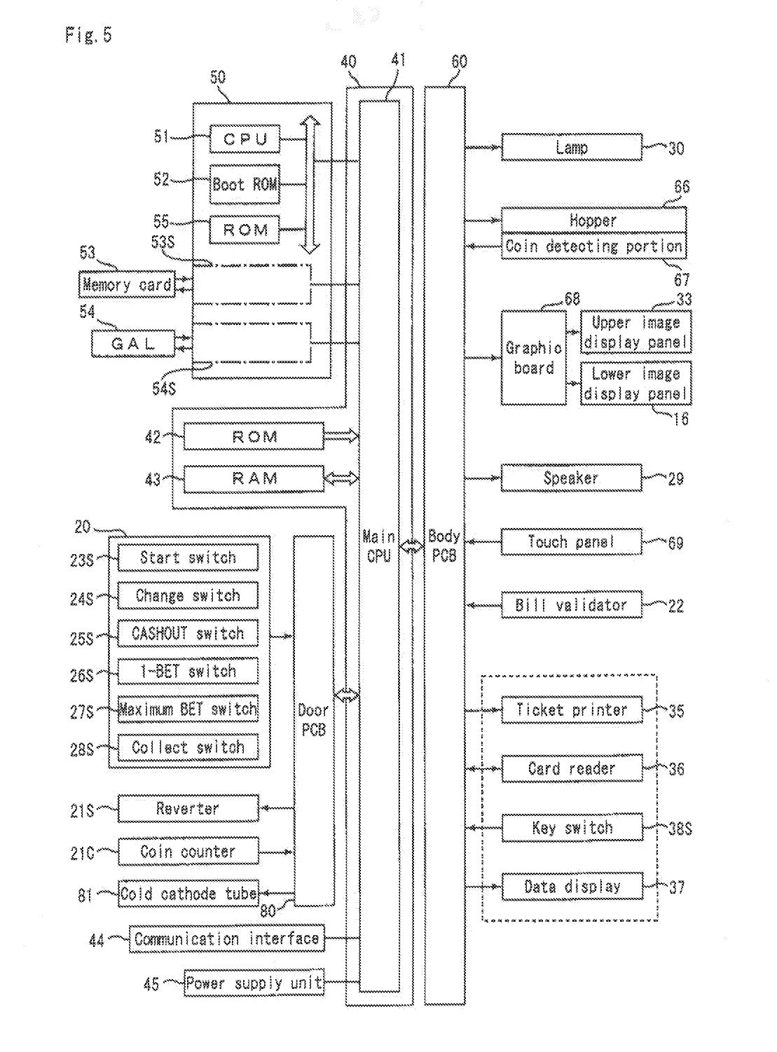

FIG. 5 is a block diagram showing an internal configuration of the gaming apparatus shown in FIG. 4.

A gaming board 50 includes a CPU (Central Processing Unit) 51, a ROM 55 and a boot ROM 52 which are mutually connected by an internal bus, a card slot 53S designed for a memory card 53, and an IC socket 54S designed for GAL (Generic Array Logic) 54.

The memory card 53 is made of a nonvolatile memory such as CompactFlash (registered trademark) or the like and stores a game program.

Further, the card slot 53S is configured such that the memory card 53 can be inserted thereinto and ejected therefrom, and is connected with the motherboard 40 by an IDE bus. Therefore, into the memory card 53 ejected from the card slot 53S, another game program can be written, and then the memory card 53 can be inserted into the card slot 53S again, to change the type or contents of a game to be played in the gaming apparatus 10. The game program includes a program relating to the game progress. Further, the game program includes image data or sound data to be outputted during the game. Moreover, the game program includes a random number generation program for use in a poker game.

A CPU 51, a ROM 55, and a boot ROM 52 mutually connected by an internal bus, are connected to the motherboard 40 by a PCI bus. The PCI bus transmits signals between the motherboard 40 and the gaming board 50, and also supplies power from the motherboard 40 to the gaming board 50.

The motherboard 40 is configured by using a commercially available general-purpose motherboard (printed wiring board on which basic components of a personal computer are mounted), and includes a main CPU 41, a ROM (Read Only Memory) 42, a RAM (Random Access Memory) 43, and a communication interface 44. The motherboard 40 corresponds to the controller in the present invention.

The ROM 42 is made of a memory device such as flash memory, and stores a program such as BIOS (Basic Input/Output System) which is executed by the main CPU 41, and permanent data. When the BIOS is executed by the main CPU 41, processing for initializing predetermined peripherals is performed, and processing for loading a game program stored in the memory card 53 via the gaming board 50 is also started. It is to be noted that in the present invention, the ROM 42 may or may not be a contents rewritable one.

The RAM 43 stores data and programs used at the time of operation of the main CPU 41. Further, a game program can be stored into the RAM 43.

Moreover, the RAM 43 stores data on the number of credits, the number of coin-ins, the number of coin-outs and the like in one game.

Furthermore, the motherboard 40 is connected with a later-described body PCB (Printed Circuit Board) 60 and a door PCB 80 by respective USBs. Further, the motherboard 40 is connected with a power supply unit 45.

The body PCB 60 and the door PCB 80 are connected with instruments and devices that generate an input signal to be inputted into the main CPU 41, and instruments and devices whose operations are controlled by a control signal outputted from the main CPU 41. The main CPU 41 executes a game program stored in the RAM 43 based on an input signal inputted into the main CPU 41 to perform predetermined arithmetic processing and store its result into the RAM 43, or transmits a control signal to each of the instruments and devices as control processing for the instruments and devices.

The body PCB 60 is connected with a lamp 30, a hopper 66, a coin detection portion 67, a graphic board 68, the speaker 29, the touch panel 69, the bill validator 22, the ticket printer 35, the card reader 36, a key switch 38S and the data display 37. The lamp 30 lights up in a predetermined pattern based on a control signal outputted from the main CPU 41.

The hopper 66 is installed inside the cabinet 11, and pays out coins in predetermined number from the coin payout exit 19 to the coin tray 18 based on a control signal outputted from the main CPU 41. The coin detecting portion 67 is provided inside the coin payout exit 19, and outputs an input signal to the main CPU 41, when detecting that coins in predetermined number have been paid out from the coin payout exit 19.

The graphic board 68 controls an image display to the upper image display panel 33 and the lower image display panel 16, based on a control signal outputted from the main CPU 41. As shown in FIG. 1, the JP images 90 and the card images 91 (91a, 91b, 91c, 91d, 91e) are displayed to the lower image display panel 16. Further, the number of coins betted in the current game is displayed in the number-of-bets display portion 92 of the lower image display panel 16. Moreover, the number of credits stored in the RAM 43 is displayed in the number-of-credits display portion 94 of the lower image display panel 16. Furthermore, the number of coin-outs is displayed in the number-of-acquired-coins display portion 93 of the lower image display panel 16.

The graphic board 68 includes a VDP (Video Display Processor) that generates image data based on a control signal outputted from the main CPU 41, and a video RAM that temporarily stores image data generated by the VDP. It is to be noted that image data to be used by the VDP in generation of image data is included in the game program loaded from the memory card 53 and stored into the RAM 43.

The bill validator 22 not only discriminates a regular bill from a false bill, but also accepts the regular bill into the cabinet 11. Upon acceptance of the regular bill, the bill validator 22 outputs an input signal to the main CPU 41 based on the amount of the bill. The main CPU 41 stores the number of credits corresponding to the amount of the bill transmitted with the input signal.

The ticket printer 35 prints on a ticket a barcode obtained by encoding the number of credits stored in the RAM 43, a date, an identification number of the gaming apparatus 10 and the like, and outputs the ticket as the ticket 39 with a barcode.

The card reader 36 reads data from the smart card and transmits the data to the main CPU 41, or writes the data into the smart card based on a control signal from the main CPU 41. The key switch 38S is provided in the key pad 38 and outputs a predetermined input signal to the main CPU 41 when the key pad 38 is operated by the player. The data display 37 displays data read by the card reader 36 or data inputted by the player via the key pad 38.

The door PCB 80 is connected with the control panel 20, a reverter 21S, a coin counter 21C, and a cold cathode tube 81. The control panel 20 is provided with a start switch 23 corresponding to the start button 23, a change switch 24S corresponding to the change button 24, a CASHOUT switch 25S corresponding to the CASHOUT button 25, a 1-BET switch 26S corresponding to the 1-BET button 26, a maximum BET switch 27S corresponding to the maximum BET button 27, and a collect switch 28S corresponding to the collect button 28. Each of the switches 23S to 28S outputs an input signal to the main CPU 41 when each of the corresponding buttons 23 to 28 is operated by the player.

The coin counter 21C is provided inside the coin receiving slot 21, and discriminates a regular coin from a false coin when the player inserts a coin into the coin receiving slot 21. A coin other than a regular coin is discharged from the coin payout exit 19. Further, the coin counter 21C outputs an input signal to the main CPU 41 when detecting a regular coin.

The reverter 21S operates based on a control signal outputted from the main CPU 41, and distributes coins recognized by the coin counter 21C as regular coins into a cash box (not shown) or the hopper 66, which are installed inside the gaming apparatus 10. Namely, when the hopper 66 is filled with coins, the reverter 21S distributes the regular coins to the cash box. On the other hand, when the hopper 66 is not filled with coins, the regular coins are distributed to the hopper 66. The cold cathode tube 81 functions as a back light installed on a rear face sides of the lower image display panel 16 and the upper image display panel 33, and is lit up based on a control signal outputted from the main CPU 41.

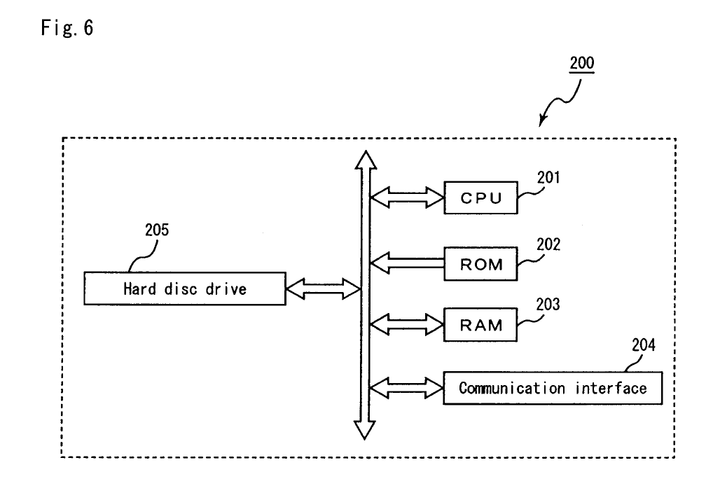

FIG. 6 is a block diagram showing an internal configuration of the server shown in FIG. 4.

The server 200 includes a CPU 201, a ROM 202, a RAM 203, a communication interface 204 and a hard disc drive 205. The communication interface 204 is connected with the communication interface 44 of each gaming apparatus 10 via the communication line 101. The ROM 202 stores a system program, permanent data and the like for controlling the operation of the server 200. Further, the RAM 203 temporarily stores an arithmetic result, data on the operation of the server 200, and the like.

Further, the hard disc drive 205 stores a progressive jackpot storage table (hereinafter also referred to as “JP storage table”) for storing coins betted at each gaming apparatus 10, for each JP.

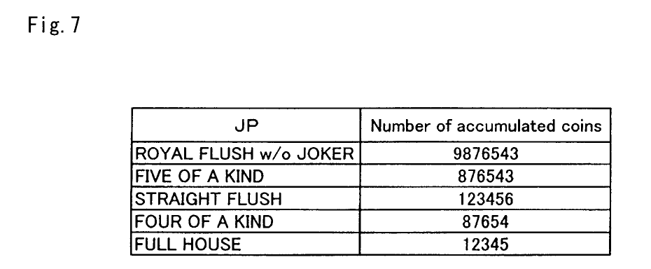

FIG. 7 is a view showing an exemplary progressive jackpot storage table.

As shown in FIG. 7, a part of BET coins are stored for each type of JP, in the JP storage table. For each type of the JPs, the part of BET coins are divided at a predetermined ratio to be stored. For example, as the JP for ROYAL FLUSH, 0.15% of betted credits are stored. As the JP for FIVE OF A KIND, 0.20% of betted credits are stored. As the JP for STRAIGHT FLUSH, 0.30% of betted credits are stored. As the JP for FOUR OF A KIND, 0.40% of betted credits are stored. As the JP for FULL HOUSE, 0.50% of betted credits are stored.

The JP storage table shown in FIG. 7 shows that: 9876543 coins are stored as the JP for ROYAL FLUSH; 876543 coins are stored as the JP for FIVE OF A KIND; 123456 coins are stored as the JP for STRAIGHT FLUSH; 87654 coins are stored as the JP for FOUR OF A KIND, and 12345 coins are stored as the JP for FULL HOUSE.

Next, processing performed in the gaming apparatus 10 is described.

The main CPU 41 reads a game program and executes it to progress a game.

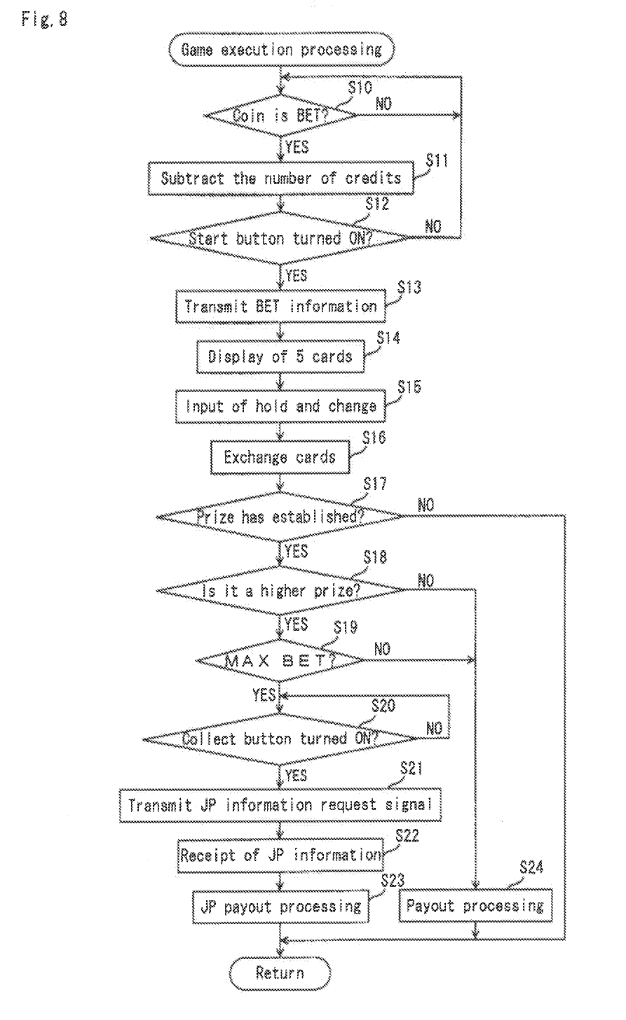

FIG. 8 is a flowchart showing a subroutine of game execution processing executed by the gaming apparatus.

First, the main CPU 41 included in the gaming apparatus 10 determines whether or not coins have been BET (step S10). In this processing, the main CPU 41 determines whether or not to have received an input signal outputted from the 1-BET switch 26S when the 1-BET button 26 is operated, or an input signal outputted from the maximum BET switch 27S when the maximum BET button 27 is operated. When determining that no coin has been betted, the main CPU 41 returns processing to step S10.

On the other hand, when determining in step S10 that coins have been BET, the main CPU 41 performs processing of subtracting from the number of credits stored in the RAM 43, according to the number of BET coins (step S11). It is to be noted that, when the number of BET coins is larger than the number of credits stored in the RAM 43, the main CPU 41 does not execute the processing of subtracting from the number of credits stored in the RAM 43, and returns the processing to step S10. Further, when the number of BET coins exceeds an upper limit value (five coins in the present embodiment) that can be betted on one game out of credited coins, the main CPU 41 does not execute the processing of subtracting from the number of credits stored in the RAM 43, and advances the processing to step S12.

In step S12, the main CPU 41 determines whether or not the start button 23 has been turned ON. In this processing, the main CPU 41 determines whether or not to have received an input signal outputted from the start switch 23S when the start button 23 has been pressed. When determining that the start button 23 has not been turned ON, the main CPU 41 returns the processing to step S10. It is to be noted that, when the start button 23 has not been turned ON (e.g. when the start button 23 has not been turned ON and a command to finish the game is inputted), the main CPU 41 cancels the subtraction result in step S11.

When determining in step S12 that the start button 23 has been turned ON, the main CPU 41 transmits BET information showing the number of BET coins, to the server 200 (step S13).

Next, in step S14, the main CPU 41 executes a random number generation program included in the game program, to acquire random numbers. The main CPU 41 then selects five cards from 52 playing cards based on the acquired random numbers according to the generated order, and displays the cards to the lower image display panel 16.

Next, in step S15, the main CPU 41 accepts an input of a hold and a change. In this processing, the player selects a card image 91 that he or she desires to change and then makes a confirmation input, whereby the main CPU 41 determines that the selected card is a card to be changed.

Next, in step S16, the main CPU 41 exchanges a card determined as the card to be changed. In this processing, the main CPU 41 executes the random number generation program included in the game program, to acquire random numbers in number equivalent to the number of cards to be changed. Subsequently, the main CPU 41 selects a new card from the playing cards not yet dealt, based on the acquired random number, and displays the selected card to the lower image display panel 16.

Next, in step S17, the main CPU 41 determines whether or not any prize has been established based on a combination of the five cards after the change. When determining that a prize has not been established, the main CPU 41 ends the present subroutine.

When determining in step S17 that any prize has been established, the main CPU 41 determines whether or not the established prize is a higher prize (step S18). When determining that the established prize is a higher prize, the main CPU 41 determines whether or not the bet is the MAXBET (step S19). In this processing, the main CPU 41 determines whether or not the number of credits having been subtracted in step S11 is five.

When determining in step S18 that the established prize is not a higher prize, or determining in step S19 that the bet is not the MAXBET, the main CPU 41 pays out coins corresponding to the type of the prize and the number of BETs according to the payout values shown in FIG. 2.

When determining in step S19 that the bet is the MAXBET, the main CPU 41 determines whether or not the collect button 28 has been turned ON (step S20). In this processing, the main CPU 41 determines whether or not to have received an input signal outputted from the collect switch 28S when the collect button 28 is pressed. When determining that the collect button 28 has not been turned ON, the main CPU 41 returns the processing to step S20.

In step S21, the main CPU 41 transmits to the server 200 a signal requesting JP information that shows a JP corresponding to the established higher prize. The JP information corresponds to the jackpot information in the present invention.

Next, in step S22, the main CPU 41 receives JP information, which is transmitted from the server 200 in response to the signal transmitted in step S21. For example, when a signal requesting JP information on ROYAL FLUSH is transmitted in step S20, the JP information showing 9876543 coins is received.

Next, in step S23, the main CPU 41 pays out the number of coins shown by the received JP information, and ends the present subroutine.

As thus described, when the player operates the collect button 28 after acquirement of the right to receive a payment of a JP, namely after establishment of a higher prize in a game with the MAXBET, a JP at that time point is paid out. Since the game is in progress in other gaming apparatuses 10 even after acquirement of the right for the player to receive the payment of the JP, BET information is transmitted by another gaming apparatus 10 to the server 200, and thus the JP continues to increase. Therefore, the player can acquire a larger JP by operating the collect button 28 as late timing as possible. However, when the right for a player to receive the payout of the JP is generated in another gaming apparatus 10 and the collect button 28 is operated earlier at this gaming apparatus 10, the JP is paid out to the player of this gaming apparatus 10.

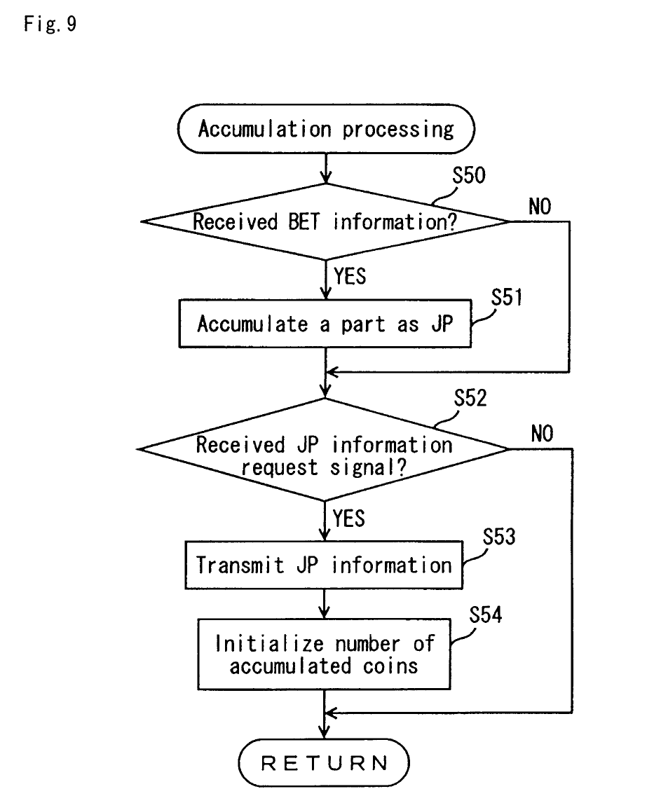

FIG. 9 is a flowchart showing a subroutine of accumulation processing executed by the server.

First, the CPU 201 included in the server 200 determines whether or not to have received BET information (see step S13 in FIG. 8) transmitted from the gaming apparatus 10 (step S50). When determining to have received BET information, the CPU 201 divides a part of the BET shown by the received BET information at a predetermined ratio to accumulate as a plurality of JPs (step S51).

When determining in step S50 that no BET information has been received, or after the processing of step S51, the CPU 201 determines whether or not to have received a signal requesting JP information (step S52). When determining that a signal requesting JP information has not been received, the CPU 201 ends the present subroutine. On the other hand, when determining that a signal requesting JP information has been received, JP information corresponding to the received signal is transmitted to the gaming apparatus 10 (step S53). For example, when a signal requesting JP information on ROYAL FLUSH is received, JP information showing 9876543 coins is transmitted.

Next, in step S54, the CPU 201 initializes the number of accumulated coins of JP corresponding to the transmitted JP information. In the present embodiment, the respective initial numbers are: 1000000 for ROYAL FLUSH; 50000 for FIVE OF A KIND; 10000 for STRAIGHT FLUSH; 5000 for FOUR OF A KIND; and 1000 for FULL HOUSE. After the processing of the step S54, the CPU 201 ends the present subroutine.

As thus described, the gaming apparatus 10 includes: the lower image display panel 16 (display) capable of displaying 5 cards; the touch panel 69 (input switch) with which a player can input a hold and/or a change; and the motherboard 40 (controller). The motherboard 40 is programmed so as to execute the processing of: (a) transmitting BET information showing the BET placed by the player, to the server 200 connected via the communication line 101; (b) displaying the 5 cards to the lower image display panel 16; (c) detecting an input of a hold and/or a change from the touch panel 69; (d) exchanging a card according to the detection; (e) determining a prize according to a combination of the 5 cards after the exchange; and (f) when the determined prize is a higher prize among a plurality of prizes, acquiring jackpot information showing a progressive jackpot corresponding to the determined higher prize from the server 200 in which at least a part of the BET that the BET information shows is cumulatively accumulated as 5 types of progressive jackpots, and also paying out the progressive jackpot shown by the jackpot information.

Although the case of executing a card game (poker game) using the gaming apparatus 10 has been described in the present embodiment, the present invention is not limited to this example. For example, a card game may be played by a plurality of players without using a gaming apparatus. In this case, a playing method of a card game including the following steps (a) to (d) can be adopted: (a) dealing a plurality of cards; (b) exchanging a card according to a hold and/or a change; (c) determining a prize according to a combination of the plurality of cards after the exchange; and (d) paying out to a player a progressive jackpot made by cumulatively accumulating a part of abet from each player, when the determined prize is a higher prize among a plurality of prizes.

Although the present invention has been described with reference to embodiments thereof, these embodiments merely illustrate specific examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming apparatus comprising:
a display capable of displaying a plurality of cards;
an input switch with which a player can input a hold and/or a change; and
a controller programmed so as to execute the processing of:
(a) displaying a plurality of cards to said display;
(b) detecting an input of a hold and/or a change from said input switch;
(c) exchanging a card according to said detection;
(d) determining a prize according to a combination of the plurality of cards after the exchange; and
(e) generating a bonus when the determined prize is a higher prize among a plurality of prizes.

2. A gaming apparatus comprising:
a display capable of displaying a plurality of cards;
an input switch with which a player can input a hold and/or a change; and
a controller programmed so as to execute the processing of:
(a) displaying a plurality of cards to said display;
(b) detecting an input of a hold and/or a change from said input switch;
(c) exchanging a card according to said detection;
(d) determining a prize according to a combination of the plurality of cards after the exchange; and
(e) paying out a progressive jackpot made by cumulatively accumulating a part of a bet from each player, when the determined prize is a higher prize among a plurality of prizes.

3. A gaming apparatus comprising:
a display capable of displaying a plurality of cards;
an input switch with which a player can input a hold and/or a change; and
a controller programmed so as to execute the processing of:
(a) transmitting currency value information showing a currency value betted by the player, to a server connected via a communication line;
(b) displaying a plurality of cards to said display;
(c) detecting an input of a hold and/or a change from said input switch;
(d) exchanging a card according to said detection;
(e) determining a prize according to a combination of the plurality of cards after the exchange; and
(f) when the determined prize is a higher prize among a plurality of prizes, acquiring jackpot information showing a progressive jackpot from said server in which at least a part of said currency value that said currency value information shows is cumulatively accumulated as said progressive jackpot, and also paying out the progressive jackpot shown by said jackpot information.

4. A gaming apparatus comprising:
a display capable of displaying a plurality of cards;
an input switch with which a player can input a hold and/or a change; and
a controller programmed so as to execute the processing of:
(a) transmitting currency value information showing a currency value betted by the player, to a server connected via a communication line;
(b) displaying a plurality of cards to said display;
(c) detecting an input of a hold and/or a change from said input switch;
(d) exchanging a card according to said detection;
(e) determining a prize according to a combination of the plurality of cards after the exchange; and
(f) when the determined prize is a higher prize among a plurality of prizes, acquiring jackpot information showing a progressive jackpot corresponding to the determined higher prize from said server in which at least a part of said currency value that said currency value information shows is cumulatively accumulated as a plurality of types of progressive jackpots, and also paying out the progressive jackpot shown by said jackpot information.

5. A playing method of a card game comprising the steps of:
(a) dealing a plurality of cards;
(b) exchanging a card according to a hold and/or a change;
(c) determining a prize according to a combination of the plurality of cards after the exchange; and
(d) offering a bonus to a player when the determined prize is a higher prize among a plurality of prizes.

6. A playing method of a card game comprising the steps of:
(a) dealing a plurality of cards;
(b) exchanging a card according to a hold and/or a change;
(c) determining a prize according to a combination of the plurality of cards after the exchange; and
(d) paying out to a player a progressive jackpot made by cumulatively accumulating a part of a bet from each player, when the determined prize is a higher prize among a plurality of prizes.
